(19) United States
(12) Patent Application Publication
(10) Pub. No.: US 2025/0314840 A1
(43) Pub. Date: Oct. 9, 2025

(54) OPTICAL WAVEGUIDE COMPONENT

(71) Applicant: SHINKO ELECTRIC INDUSTRIES CO., LTD., Nagano (JP)

(72) Inventor: Yuji FURUTA, Nagano (JP)

(21) Appl. No.: 19/097,200

(22) Filed: Apr. 1, 2025

(30) Foreign Application Priority Data
Apr. 5, 2024 (JP) 2024-061263

(51) Int. Cl. G02B 6/42

(52) U.S. Cl. CPC G02B 6/4214

(57) ABSTRACT

An optical waveguide component includes a substrate having a first principal surface, an optical waveguide provided on the first principal surface and including a first core, and a first optical connector fixed to the first principal surface. The first optical connector includes a first mirror provided on a first optical axis of the first core. The first mirror has a second optical axis inclined from the first optical axis, and is configured to reflect light incident from the first core as collimated light.

### CROSS-REFERENCE TO RELATED APPLICATIONS

This application is based upon and claims priority to Japanese Patent Application No. 2024-061263, filed on Apr. 5, 2024, the entire contents of which are incorporated herein by reference.

### FIELD

Certain aspects of the embodiments discussed herein are related to optical waveguide components.

### BACKGROUND

Various techniques have been proposed for optically coupling an optical fiber to an optical waveguide provided on a substrate.

Related art include Japanese Laid-Open Patent Publication No. 2011-081299, Japanese Laid-Open Patent Publication No. 2015-114645, and A. Noriki et al., “Low-Cost MT-Ferrule-Compatible Optical Connector for Co-packaged Optics Using Single-Mode Polymer Waveguide”, Electronic Components and Technology Conference, 1 May 2019, for example.

It is difficult to obtain a high coupling efficiency between the optical waveguide and the optical fiber according to the conventional techniques.

### SUMMARY

Accordingly, it is an object in one aspect of the embodiments to provide an optical waveguide component capable of obtaining a high coupling efficiency between an optical waveguide and an optical fiber.

According to one aspect of the embodiments, an optical waveguide component includes a substrate having a first principal surface; an optical waveguide provided on the first principal surface and including a first core; and a first optical connector fixed to the first principal surface, wherein the first optical connector includes a first mirror provided on a first optical axis of the first core, and the first mirror has a second optical axis inclined from the first optical axis, and is configured to reflect light incident from the first core as collimated light.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a plan view illustrating an example of an optical waveguide component according to one embodiment;

FIG. 2 is a cross sectional view (part 1) illustrating the example of the optical waveguide component according to one embodiment; and

FIG. 3 is a cross sectional view (part 2) illustrating the example of the optical waveguide component according to one embodiment.

### DESCRIPTION OF EMBODIMENTS

Preferred embodiments of the present invention will be described with reference to the accompanying drawings. In the specification and the drawings, those parts that are the same are designated by the same reference numerals, and a redundant description thereof may be omitted.

### [Configuration of Optical Waveguide Component]

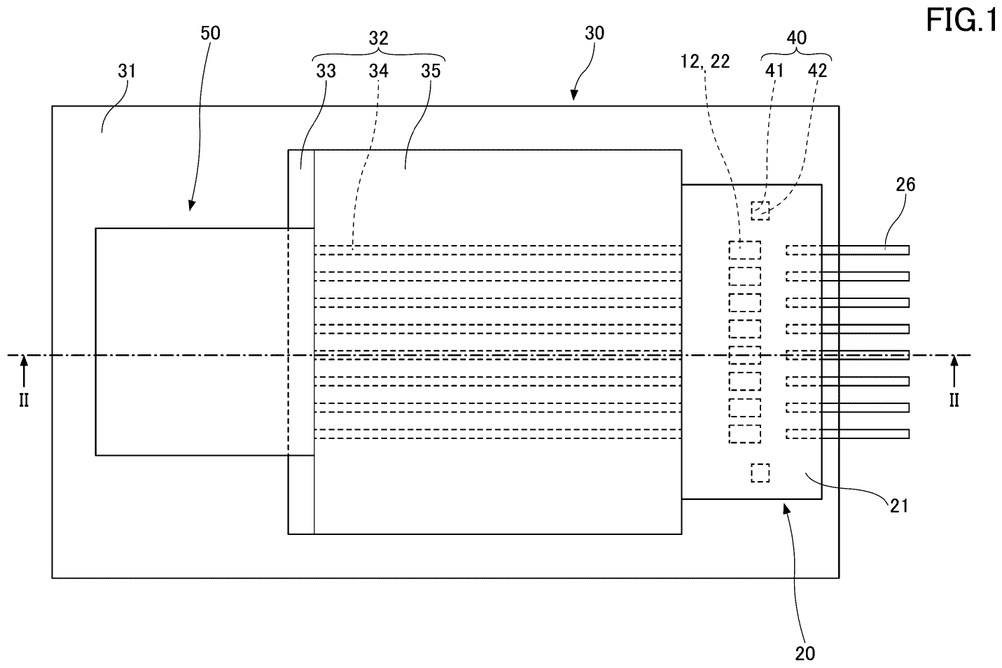

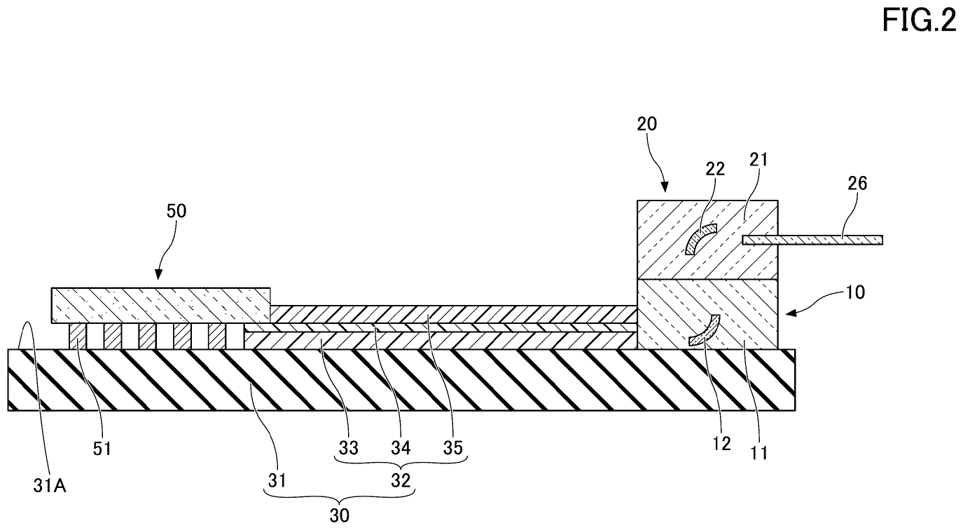

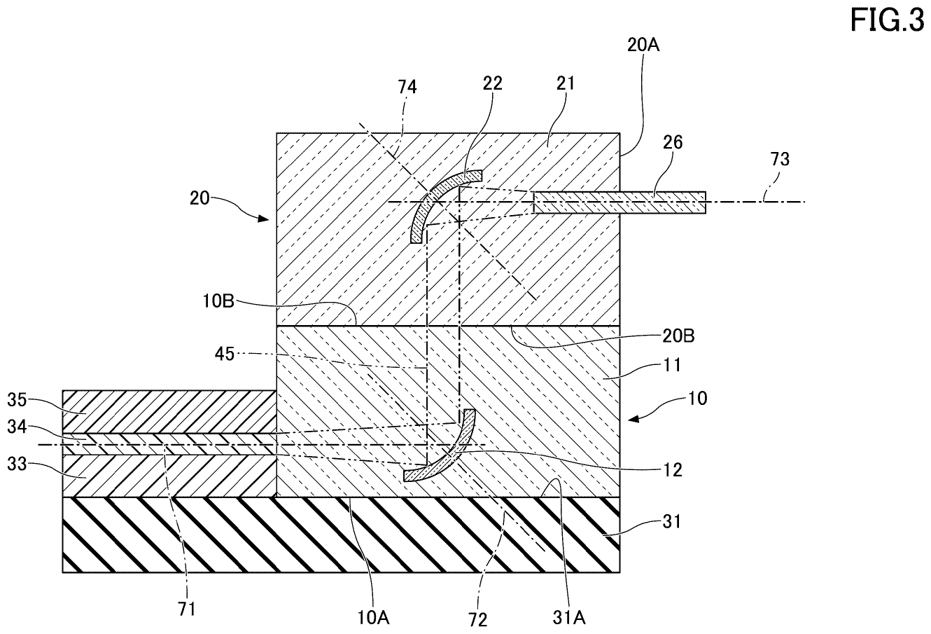

A configuration of an optical waveguide component according to one embodiment will be described. FIG. 1 is a plan view illustrating an example of the optical waveguide component according to one embodiment. FIG. 2 and FIG. 3 are cross sectional views illustrating the example of the optical waveguide component according to one embodiment. FIG. 2 corresponds to a cross sectional view taken along a line II-II in FIG. 1. FIG. 3 illustrates a part of FIG. 2 on an enlarged scale.

As illustrated in FIG. 1 through FIG. 3, an optical waveguide component 1 according to one embodiment includes an optical waveguide substrate 30, a first optical connector 10, a second optical connector 20, and an optical semiconductor chip 50.

The optical waveguide substrate 30 includes a substrate 31 and an optical waveguide 32.

The substrate 31 is a wiring board, for example, and includes one or more interconnect patterns (not illustrated) and electrodes (not illustrated). The optical waveguide 32 is provided on one principal surface 31A of the substrate 31. The principal surface 31A is an example of a first principal surface.

In the present embodiment, for the sake of convenience, an upper side or one side and a lower side or the other side of the optical waveguide component 1 are specified with reference to the substrate 31. More particularly, the side of the optical waveguide component 1 provided with the optical waveguide 32 is referred to as the upper side or the one side, and the opposite side of the optical waveguide component 1 not provided with the optical waveguide 32 is referred to as the lower side or the other side. An upper surface of each portion of the optical waveguide component 1 is referred to as one surface or an upper surface, and a lower surface of each portion of the optical waveguide component 1 is referred to as the other surface or a lower surface. However, the optical waveguide component 1 can be used in an upside-down state or can be arranged at an arbitrary angle. Further, a plan view of each portion of the optical waveguide component 1 refers to a view thereof viewed from above and in a normal direction to the principal surface 31A of the substrate 31. A planar shape of each portion of the optical waveguide component refers to the shape of the each portion in the plan view viewed from above in the normal direction of the principal surface 31A of the substrate 31.

The optical waveguide 32 includes a first cladding layer 33, a plurality of core layers 34, and a second cladding layer 35. The optical waveguide 32 is a polymer waveguide. The core layer 34 is an example of a first core.

The first cladding layer 33 is provided on the substrate 31. A material used for the first cladding layer 33 may be an organic resin, such as an epoxy resin, a polyimide resin, or the like, for example. A thickness of the first cladding layer 33 may be in a range of approximately 10 μm to approximately 30 μm, for example.

The plurality of core layers 34 are provided in a band shape on the first cladding layer 33. A material used for the core layers 34 may be an organic resin, such as an epoxy resin, a polyimide resin, or the like, for example. For example, a cross sectional shape of the core layer 34, perpendicular to an extending direction in which the core layer 34 extends, may be rectangular. In order to obtain a single-mode optical waveguide, the core layer 34 may have a very small cross sectional area. For example, a width of the core layer 34 may be in a range of 5 μm to 10 μm, and a height of the core layer 34 may be in a range of 5 μm to 10 μm.

The second cladding layer 35 is provided on the first cladding layer 33 and the plurality of core layers 34. The second cladding layer 35 covers the plurality of core layers 34. A material used for the second cladding layer 35 may be an organic resin, such as an epoxy resin, a polyimide resin, or the like, for example. A thickness of the second cladding layer 35 may be in a range of approximately 10 μm to approximately 30 μm, for example. A portion of the core layer 34 may be exposed from the second cladding layer 35 on both sides of the core layer 34 in the extending direction.

In the optical waveguide 32, a refractive index of the core layer 34 is higher than refractive indexes of the first cladding layer 33 and the second cladding layer 35.

The optical semiconductor chip 50 includes an optical element (not illustrated), and is mounted on the substrate 31. The optical semiconductor chip 50 has a plurality of electrodes 51, and is flip-chip bonded to the substrate 31. The optical semiconductor chip 50 is disposed on one side of the core layers 34 along the extending direction, and the optical element is optically coupled to the optical waveguide 32. The optical element may be either a light receiving element or a light emitting element.

The first optical connector 10 is disposed on an opposite side from the optical semiconductor chip 50 in the extending direction of the core layer 34, and is fixed to the principal surface 31A of the substrate 31. The first optical connector 10 is bonded to the principal surface 31A using an adhesive, for example. The first optical connector 10 includes a first glass member 11, and a plurality of first mirrors 12. The first optical connector 10 has a surface 10A opposing the substrate 31, and a surface 10B opposite from the surface 10A.

The number of first mirrors 12 is equal to the number of core layers 34. The first mirror 12 is located on a first optical axis 71 of the core layer 34, and one first mirror 12 and one core layer 34 constitute a pair. In each pair, the first mirror 12 has a second optical axis 72 inclined from the first optical axis 71, and can reflect light incident from the core layer 34 as collimated light. On the other hand, the first mirror 12 can also focus the collimated light incident from a specific direction onto the core layer 34. The first mirror 12 is a concave mirror, for example. For example, the first optical axis 71 is parallel to the principal surface 31A, and the second optical axis 72 is inclined by 45 degrees from the first optical axis 71. The first mirror 12 can collimate and reflect light incident from the core layer 34 in a direction inclined by 90 degrees, and can focus the collimated light incident from the specific direction inclined by 90 degrees from the first optical axis 71 onto the core layer 34.

The second optical connector 20 includes a second glass member 21, a plurality of second mirrors 22, and a plurality of optical fiber cores 26. The number of second mirrors 22 and the number of optical fiber cores 26 are equal to the number of core layers 34 and the number of first mirrors 12. The second glass member 21 can function as a cladding with respect to the optical fiber core 26. The optical fiber core 26 is an example of a second core.

The second optical connector 20 has a surface 20A and a surface 20B continuous with the surface 20A. For example, an angle formed by the surfaces 20A and 20B is 90 degrees. In the second glass member 21, third optical axes 73 of the optical fiber cores 26 are parallel to one another among the plurality of optical fiber cores 26. For example, the surface 20B is parallel to the third optical axis 73 of the optical fiber core 26 in the second glass member 21. The optical fiber core 26 extends outward from the surface 20A.

The second mirror 22 is located on the third optical axis 73 of the optical fiber core 26, and one second mirror 22 and one optical fiber core 26 constitute a pair. In each pair, the second mirror 22 has a fourth optical axis 74 inclined from the third optical axis 73, and can reflect light incident from the optical fiber core 26 as collimated light. The second mirror 22 can also focus the collimated light incident from a specific direction onto the optical fiber core 26. The second mirror 22 is a concave mirror, for example. For example, the fourth optical axis 74 is inclined by 45 degrees from the third optical axis 73, and the second mirror 22 can collimate and reflect the light incident from the optical fiber core 26 in a direction inclined by 90 degrees. The second mirror 22 can also focus the collimated light incident from the specific direction inclined by 90 degrees from the third optical axis 73 onto the optical fiber core 26.

The second optical connector 20 is attachable to and detachable from the first optical connector 10. In other words, the second optical connector 20 is detachably attached to the first optical connector 10. When the second optical connector 20 is connected to the first optical connector 10, the surface 10B of the first optical connector 10 and the surface 20B of the second optical connector 20 oppose each other. In addition, the optical waveguide component 1 includes a constraining mechanism 40. The constraining mechanism 40 includes a plurality of fitting holes 41 provided in the surface 10B, and a plurality of fitting pins 42 provided on the surface 20B and fitted into the fitting holes 41, respectively. For example, the fitting holes 41 are located on both outer sides of the outermost first mirrors 12 located on the outermost sides in the direction in which the plurality of first mirrors 12 are arranged. Further, the fitting pins 42 are located on both outer sides of the outermost optical fiber cores 26 located on the outermost sides in the direction in which the plurality of optical fiber cores 26 are arranged. The fitting pins 42 are fitted into the fitting holes 41, and thus, the first optical connector 10 and the second optical connector 20 are mechanically constrained from being positionally displaced from each other in directions parallel to the surfaces 10B and 20B. Each first mirror 12 of the plurality of first mirrors 12 opposes one second mirror 22 of the plurality of second mirrors 22 to constitute a pair of mutually opposing first and second mirrors 12 and 22, and a signal of collimated light 45 is transmitted between the pairs of mutually opposing first and second mirrors 12 and 22. Accordingly, the constraining mechanism 40 constrains the first optical connector 10 and the second optical connector 20 to each other in the directions parallel to the principal surface 31A. Preferably, mode field diameters (MFDs) of the core layer 34 and the optical fiber core 26 match.

The positions of the fitting holes 41 and the fitting pins 42 are not particularly limited. The fitting holes 41 may be located on both sides of a row of the first mirrors 12 in the extending direction of the core layer 34, and the fitting pins 42 may be located on both sides of a row of the second mirrors 22 in an extending direction in which the optical fiber core 26 extends.

### [Method for Manufacturing Optical Waveguide Component and Method for Using the Same]

Next, a method for manufacturing the optical waveguide component according to the embodiment, and a method for using the optical waveguide component according to the embodiment, will be described.

First, the optical waveguide substrate 30 is prepared, and the optical semiconductor chip 50 is mounted on the substrate 31. Next, the first optical connector 10 is fixed to the optical waveguide substrate 30. The first optical connector 10 can be fixed to the optical waveguide substrate 30 using a light-transmitting adhesive, for example.

The optical waveguide component 1 is used by connecting the first optical connector 10 and the second optical connector 20. When connecting the first optical connector 10 and the second optical connector 20, the second optical connector 20 is pressed against the first optical connector 10 while fitting the fitting pins 42 into the fitting holes 41, respectively. Then, the second optical connector 20 is fixed to the first optical connector 10. The second optical connector 20 can be detachably fixed to the first optical connector 10 using a latch mechanism or the like, for example.

The optical waveguide component 1 according to the embodiment can be manufactured and used in the manner described above.

In the optical waveguide component 1, the collimated light 45 via the first mirror 12 and the second mirror 22 is used for transmitting the light between the core layer 34 and the optical fiber core 26. For this reason, a loss is small, and a coupling efficiency can be improved.

For example, a slight margin may exist between the fitting hole 41 and the fitting pin 42, and an optical axis of the light incident from the core layer 34 and reflected by the first mirror 12, and an optical axis of the light incident from the optical fiber core 26 and reflected by the second mirror 22 may slightly deviate from each other in the direction parallel to the principal surface 31A. Even if such a deviation exists, the light emitted from the first mirror 12 is focused onto an end surface of the optical fiber core 26, and the light emitted from the second mirror 22 is focused onto an end surface of the core layer 34, by using the collimated light 45. Hence, the core layer 34 and the optical fiber core 26 can be optically coupled by passive alignment.

In addition, because the first optical connector 10 is fixed to the principal surface 31A of the substrate 31, the first optical connector 10 can be bonded to the substrate 31 via a large area regardless of the thicknesses of the substrate 31. Accordingly, a high adhesive strength can be obtained. Further, when removing the second optical connector 20 from the first optical connector 10, the second optical connector 20 is pulled in a direction perpendicular to the principal surface 31A. For this reason, the first optical connector 10 is less likely to be separated from the substrate 31 when removing the second optical connector 20 from the first optical connector 10.

The second optical connector 20 may be composed of a plurality of components or constituent elements. For example, the second optical connector 20 may be configured by bonding a component including the optical fiber cores 26 having exposed end surfaces, and a component including the second mirrors 22, to each other.

According to the present disclosure, a high coupling efficiency can be obtained between an optical waveguide and an optical fiber.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical waveguide component comprising:
a substrate having a first principal surface;
an optical waveguide provided on the first principal surface and including a first core; and
a first optical connector fixed to the first principal surface, wherein:
the first optical connector includes a first mirror provided on a first optical axis of the first core, and
the first mirror has a second optical axis inclined from the first optical axis, and is configured to reflect light incident from the first core as collimated light.

2. The optical waveguide component as claimed in claim 1, wherein the first mirror is a concave mirror.

3. The optical waveguide component as claimed in claim 1, wherein the optical waveguide is a polymer waveguide.

4. The optical waveguide component as claimed in claim 1, wherein:
the first optical axis is parallel to the first principal surface, and
the second optical axis is inclined at 45 degrees from the first optical axis.

5. The optical waveguide component as claimed in claim 1, further comprising:
a second optical connector including a second mirror and detachably attached to the first optical connector,
wherein a signal of collimated light is transmitted between the first mirror and the second mirror.

6. The optical waveguide component as claimed in claim 5, wherein:
the second optical connector includes a second core of an optical fiber, and
the second mirror is provided on a third optical axis of the second core, includes a fourth optical axis inclined from the third optical axis, and is configured to reflect light incident from the second core as collimated light.

7. The optical waveguide component as claimed in claim 5, wherein the second mirror is a concave mirror.

8. The optical waveguide component as claimed in claim 5, further comprising;
a constraining mechanism configured to constrain the first optical connector and the second optical connector from each other in a direction parallel to the first principal surface.

9. The optical waveguide component as claimed in claim 1, further comprising:
an optical semiconductor chip mounted on the substrate and optically coupled to the optical waveguide.
